(19) United States
(12) Patent Application Publication
(10) Pub. No.: US 2004/0214145 A1
(43) Pub. Date: Oct. 28, 2004

(54) Sentence-conversation teaching system with environment and role selections and method of the same

(76) Inventors: Say-Ling Wen, Taipei (TW); Zechary Chang, Taipei (TW); Pinky Ma, Beijing (CN)

Correspondence Address: BIRCH STEWART KOLASCH & BIRCH, PO BOX 747, FALLS CHURCH, VA, 22040-0747, US

(21) Appl. No.: 10/420,849

(22) Filed: Apr. 23, 2003

(51) Int. Cl. G09B 19/00

(52) U.S. Cl. 434/167

(57) ABSTRACT

The specification discloses a sentence-conversation teaching system with role-play selections and the corresponding method. Before performing unit teaching process, the user can select an environment and role according to his or her preference and learning need. The disclosed system finds the teaching material corresponding to the environment and role for the user to perform sentence-making and conversation learning and evaluation. Each teaching unit contains materials of different environments and roles for the user to more easily understand the materials during the learning process. The evaluation result given during the sentence-making and conversation learning process allows the user to understand his or her learning progress.

### BACKGROUND OF THE INVENTION

1. Field of Invention

The invention relates to a foreign language teaching system and the method of the same. In particular, it relates to a system and method with environment and role selections for a user to practice sentences and conversations.

2. Related Art

The ultimate goal of learning a foreign language is to be able to converse with other speakers of the same language. In either the conventional or computer-assisted foreign language teaching, there are many courses with emphasis on conversations. In order for the user to fully understand the conversation material, other encouraging factors (e.g. the environment learning method that creates an environment in the material and the role-play learning method that allows the user to play a role while learning) are often added into the teaching process to help users learning. However, a closer look at such methods one finds the following problems:

(1) Lack of sentence structure practices. An important factor in conversation ability is the user's familiarity with making sentences. It is often the case that although the user can immediately come up with an answer to a question asked by other people, he or she is not able to organize to form a correct sentence structure. As a result, the user cannot express him- or herself very fluently in practical conversations. Therefore, lacking sentence-making training will make the conversation learning in effective.

(2) Lack of a complete evaluation mechanism. In addition to correctly making a sentence during conversations, more important is the skills of intonation and pronunciation while the user speaks. Although the conventional sentence-conversation teaching puts emphasis on this part, there is always not an ideal evaluation mechanism for the user's reference. Therefore, the user keeps practicing but cannot know of the real progress he or she has made.

(3) Unable to combine the environment and role features. With no doubt, the design of both environment and role-play are extremely important encouraging learning factors. However, conventional teaching designs often do not fully combine these two features. Therefore, even if the user is familiar with various conversation environments, they may not be able to get a good hold of individual roles. A result is that the user has to spend more than twice of time in conversation practice without gaining much progress.

Consequently, it is of great importance to make good use of the popular computer technology to provide a sentence-conversation teaching system and method that combine both the environment and role-play features and offer a complete analysis and evaluation mechanism to enhance the user's conversation ability. The ultimate goal is to make the user greatly improve their conversation skill with the least effort within the shortest possible time.

### SUMMARY OF THE INVENTION

In view of the foregoing, the invention provides a sentence-conversation teaching system and the associated method with both environment and role-play selections. It is hoped that the user can select a desired environment and role set to go through a conversation unit. During the learning process, the system can give the user an explicit and accurate evaluation on the progress he or she has made.

Through the combination of the environment and role, the user can experience different material contents and grasp the conversation skills for each role in all environments. From the evaluation results given during the sentence-making and conversation practicing process, the user can know of the progress he/she has made. Through the practices of sentence-making and conversation practices, the user can receive a more thorough training in sentence structures. Eventually, the user can express better in actual conversations.

To achieve the above-mentioned objectives, the disclosed system includes: a selection module, a material database, a conversation teaching module, a sentence teaching module, and an input/output (I/O) module.

The disclosed method includes the steps of: receiving a selection of the environment and role from the user; extracting the material corresponding to the environment to start the sentence teaching; extracting the material corresponding to the role to start the conversation teaching; and computing a unit learning result and giving a evaluation grade.

### BRIEF DESCRIPTION OF THE DRAWINGS

The invention will become more fully understood from the detailed description given hereinbelow illustration only, and thus are not limitative of the present invention, and wherein:

FIG. 1 is a block diagram of the disclosed sentence-conversation teaching system module;

FIG. 2-a is the main flowchart of the disclosed sentence-conversation teaching method;

FIG. 2-b is a detailed flowchart of the sentence-making practice part; and

FIG. 2-c is a detailed flowchart of the conversation teaching part.

### DETAILED DESCRIPTION OF THE INVENTION

The disclosed sentence-conversation teaching system and method with environment and role-play selections allows the user to freely select an environment and a role. The disclosed system 100 then extracts the corresponding material for the user to perform conversation practices.

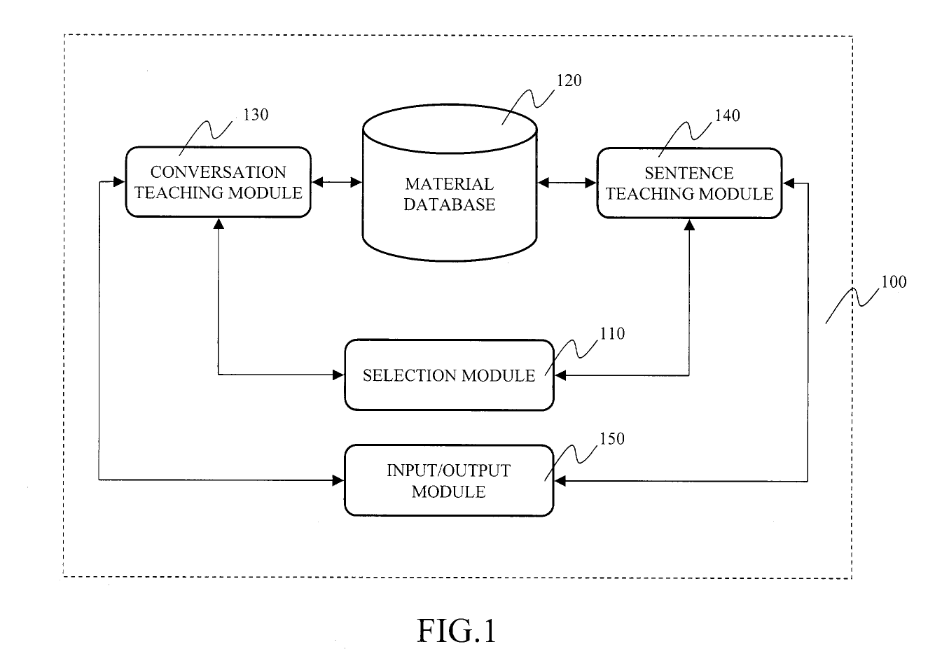

With reference to FIG. 1, the disclosed sentence-conversation teaching system 100 includes: a selection module 110, a material database 120, a conversation teaching module 130, a sentence teaching module 140, and an input/output (I/O) module 150.

(1) The selection module 110 allows the user to select an environment and a role. This includes the selection of an environment of the learning material and a setting of the role to play. The user's selection result affects the actual sentence-making practices and the material in the conversation learning.

(2) The material database 120 stores the learning materials of all environments and roles. Basically, the materials are divided into conversation units and sentence-making units. Each unit contains different data types of learning contents. They include texts, voices, pictures, videos, etc. Therefore, the material database 120 can be a database that stores multimedia data.

(3) The conversation teaching module 130 extracts the conversation learning material according to the user's role selection to perform the conversation teaching. During the conversation learning process, the conversation eaching module 130 outputs all of the selected conversation learning units one by one. Each conversation teaching process includes the following necessary parts: outputting the voice content of the other party in the conversation, receiving the user's voice content (including recoding it), performing the voice content similarity analysis (i.e. making sound wave comparison between the user's voice content and the standard voice content).

The conversation teaching module 130 repeats each of the above-mentioned steps until the conversation unit ends. Finally, an analysis result (including a unit conversation evaluation) is output for the user's reference and for evaluating the user's learning progress.

(4) The sentence teaching module 140 extracts a sentence-making learning unit according to the user's environment selection to perform the sentence teaching. During the sentence-making practices, the sentence teaching module 140 outputs all of the selected sentence learning unit. The sentence-making practice of each sentence includes the following steps: generating a question for the user to make a sentence, receiving the user's input content, making a consistency comparison for the input content (i.e. comparing the structure of the user's input content with that of the standard sentence).

The sentence teaching module 140 repeats the above-mentioned steps until all sentence-making practices in the unit are done. Finally, a comparison result (including a sentence-making practice evaluation) is output for the user's reference and for evaluating the user's learning progress.

(5) The I/O module 150 receives the input and voice content from the user during the conversation teaching and sentence teaching processes. It also outputs the contents (including the voice contents of the other party in the conversation, the questions in sentence-making practices, analysis results, comparison results, unit conversation evaluation, and unit sentence-making evaluation) provided by the conversation teaching module 130 and sentence teaching module 140. Moreover, it computes and presents a learning evaluation grade.

The learning evaluation grade is computed using the unit conversation evaluation result given by the conversation teaching module 130 and the unit sentence-making evaluation result given by the sentence teaching module 140.

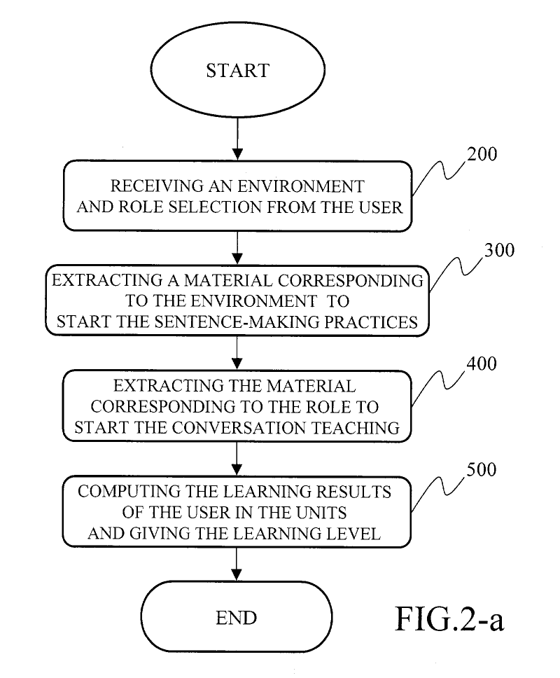

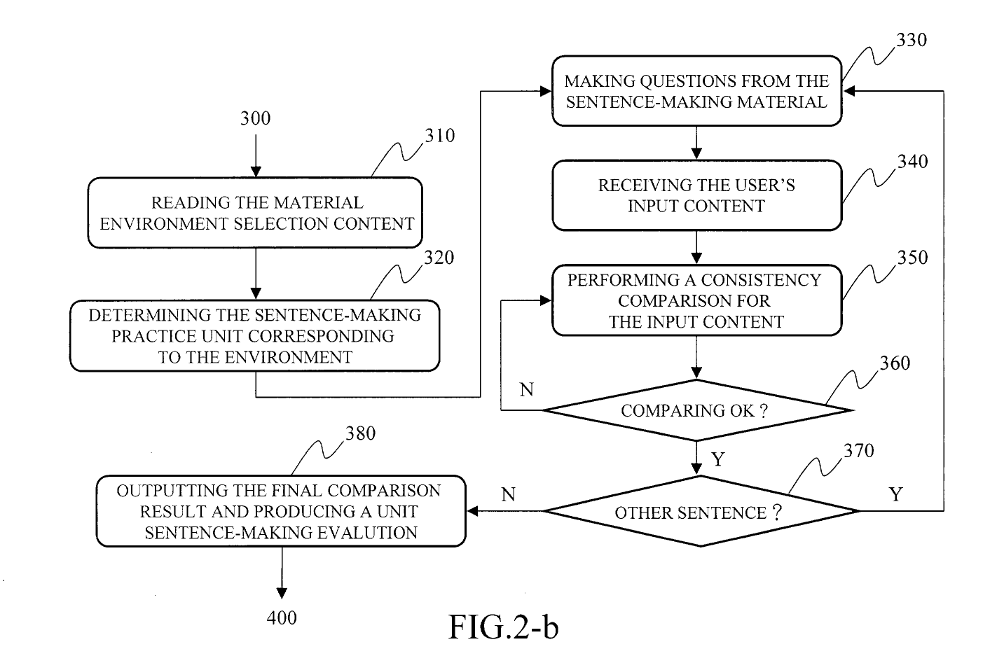

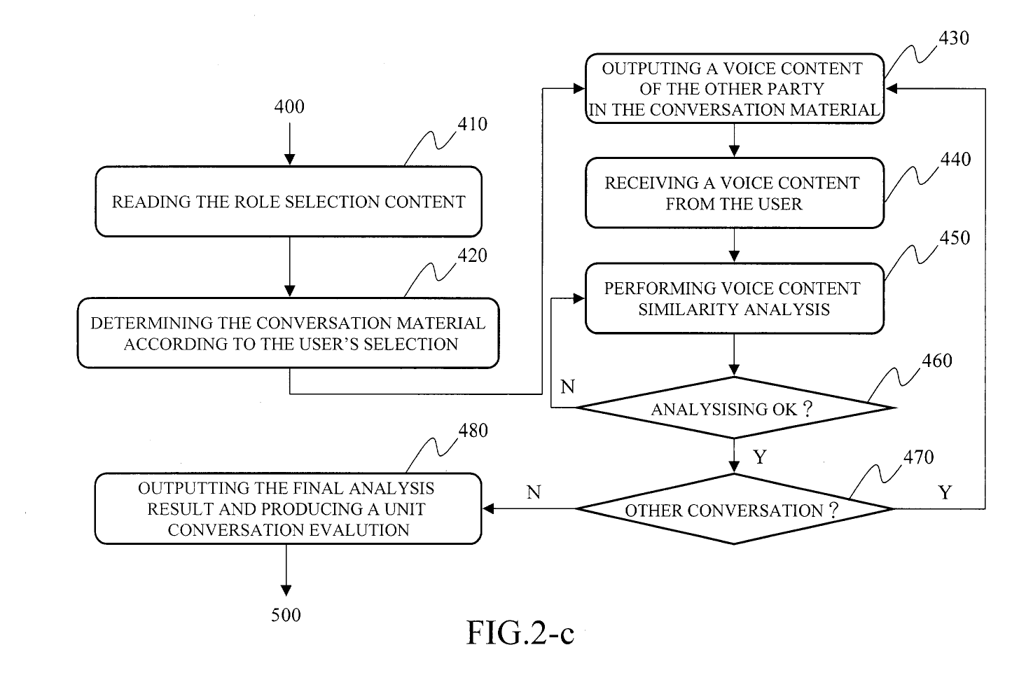

We then use FIGS. 2-a, 2-b, and 2-c to explain the disclosed method. With reference to FIG. 2-a, the method starts by receiving an environment and role selection from the user (step 200). The selection includes the choices of an environment of the material and a role therein. The disclosed sentence-conversation teaching system 100 then extracts a material corresponding to the environment to start the sentence-making practices (step 300). The related process will be explained in detail with reference to FIG. 2-b later. After the sentence-making practices are done, the material corresponding to the role is extracted to start the conversation teaching (step 400). Their detailed steps are shown in FIG. 2-c that will be explained afterwards. Finally, the unit learning results of the user in the units are computed and given for evaluating the learning grade (step 500).

With reference to FIG. 2-b, the sentence-making practices starts by reading the material environment selection content (step 310). The system then determines the sentence-making practice unit corresponding to the environment (step 320). Afterwards, the system makes questions from the sentence-making material (step 330). There are at least two methods for making questions for the user to select or for the system to randomly determine. One is the non-reorganization method, where the hint contents of a sentence-making material (such as the question version or the translation of a sentence) are output to the user for the user to enter word by word. The other is the reorganization method, where a sentence material is randomly rearranged and then output to the user or the user to enter a correct order. The reorganization method includes many different schemes: word reorganization, vocabulary attribute reorganization, vocabulary type reorganization, and interference word reorganization. The system then receives the user's input content (step 340). The user can use an input device (such as a keyboard, a hand-writing input device) to enter words and sentences. After the input content is received, the system performs a consistency comparison for the input content (step 350). In other words, the user's input sentence and the standard sentence are compared. The system checks whether the comparison is done (step 360). If not, step 350 continues; otherwise, the comparison result is temporarily stored, and the system determines whether there is any other sentence for comparison (step 370). If not, the final comparison result is output and a unit sentence-making evaluation is produced (step 380). The final comparison result comes from the statistical result of the comparison result in each sentence-making practice. It reflects the understanding level of the user in the unit. Finally, the comparison result is further used to generate the unit sentence-making evaluation in a comprehensive learning evaluation. The system then continues to step 400. If there are unprocessed sentences, steps 330 through 370 are repeated until all sentence-making practices are done.

With reference to FIG. 2-c, the conversation teaching starts by reading the role selection content (step 410). The system determines the conversation material according to the user's selection (step 420). The system outputs a voice content of the other party in the conversation material (step 430). Afterwards, the system receives a voice content from the user (step 440). The user can use an input device (such as a microphone or a voice-collecting device) to enter the voice content. After receiving the user's voice content, the system starts to perform voice content similarity analysis (step 450). It compares whether the user's voice content and the standard voice content are the same. This is usually done by comparing the sound waves. The system further determines whether the analysis is done (step 460). If not, step 450 continues; otherwise, the analysis result is temporarily stored and the system determines whether there is any other conversation to perform (step 470). If there is no further conversation, the final analysis result is output and a unit conversation evaluation is produced (step 480). The final analysis result comes from the statistical result of the analysis result in each conversation. It reflects the understanding level of the user in the conversation unit. Finally, the analysis result is further used to generate the unit conversation evaluation in a comprehensive learning evaluation. The system then continues to step 500. If there are unprocessed conversations in the unit, steps 430 through 470 are repeated until all the conversation materials in the unit are done.

Certain variations would be apparent to those skilled in the art, which variations are considered within the spirit and scope of the claimed invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sentence-conversation teaching system with environment and role selections for generating learning contents according to a user's environment and role selection to perform sentence and conversation teaching and evaluation thereof, the system comprising:
a selection module, which performs an environment and role selection setting;
a material database, which stores learning units for a plurality of environments and roles;
a conversation teaching module, which extracts a conversation learning unit to perform conversation teaching according to the role selection;
a sentence teaching module, which extracts a sentence learning unit to perform a sentence-making practice according to the environment selection; and
an input/output (I/O) module, which receives an input and voice content from the user during the conversation teaching and the sentence-making practice, displays an output from the conversation teaching module and the sentence teaching module, and compute and presents a learning evaluation grade.

2. The system of claim 1, wherein the environment and role selection setting includes at least a role to play and an environment setting.

3. The system of claim 1, wherein the material database includes at least a conversation teaching unit and a sentence-making practice unit.

4. The system of claim 3, wherein the conversation teaching unit and the sentence-making practice unit includes at least the data types of texts, voices, pictures, and videos.

5. The system of claim 1, wherein the learning evaluation grade is computed using a unit conversation evaluation and a unit sentence-making evaluation.

6. A sentence-conversation teaching method with environment and role selections for generating learning contents according to a user's environment and role selection to perform sentence and conversation teaching and evaluation thereof, the method comprising the steps of:
receiving an environment and role selection setting from the user;
extracting a material corresponding to the environment selection to perform a sentence-making practice;
extracting a material corresponding to the role selection to perform a conversation teaching; and
computing unit learning results and providing a learning evaluation grade.

7. The method of claim 6, wherein the environment and role selection setting includes at least a role to play and an environment setting.

8. The method of claim 6, wherein the step of extracting a material corresponding to the environment selection to perform a sentence-making practice comprises the steps of:
reading the environment setting content for the learning material;
determining a sentence-making practice unit corresponding to the environment setting;
generating questions from the sentence-making material;
receiving an input content from the user;
performing a consistency comparison for the input content; and
outputting a comparison result and generating a unit sentence-making practice evaluation.

9. The method of claim 8, wherein the sentence-making practice unit includes at least the data types of texts, voices, pictures, and videos.

10. The method of claim 8, wherein the step of generating questions from the sentence-making material employs a method selected from a non-reorganization method and a reorganization method.

11. The method of claim 10, wherein the reorganization method uses a scheme selected from the group consisting of word reorganization, vocabulary attribute reorganization, vocabulary type reorganization, and interference word reorganization.

12. The method of claim 6, wherein the step of extracting a material corresponding to the role selection to perform a conversation teaching comprises the steps of:
reading the role setting content for the learning material;
determining a conversation teaching unit corresponding to the role setting;
outputting a voice content of the other party in the conversation;
receiving an input voice content from the user;
performing a similarity analysis for the input voice content; and
outputting an analysis result and generating a unit conversation evaluation.

13. The method of claim 12, wherein the conversation teaching unit includes at least the data types of texts, voices, pictures, and videos.

14. The method of claim 6, wherein the learning evaluation grade is determined from the unit conversation evaluation and the unit sentence-making evaluation.
